(19) United States
(12) Patent Application Publication
(10) Pub. No.: US 2017/0098522 A1
(43) Pub. Date: Apr. 6, 2017

(54) TEMPERATURE SAFETY RESISTOR ASSEMBLY

(71) Applicant: Ty-Ohm Electronic Works Co., Ltd., Taoyuan County (TW)

(72) Inventor: Samuel Kuo, Taoyuan County (TW)

(21) Appl. No.: 14/875,975

(22) Filed: Oct. 6, 2015

(51) Int. Cl. H01H 85/02; H01H 85/04; H01H 85/20; H01C 1/14

(52) U.S. Cl. CPC H01H 85/0241; H01C 1/14; H01H 85/04; H01H 85/20

(57) ABSTRACT

A temperature safety resistor assembly includes a hollow shell, a resistor and two conductive components. The resistor is disposed within the shell and at least one of the two conductive components is welded with an end of the resistor by a low temperature solder. An elastic deformation portion is formed on the conductive component and the elastic deformation portion is deformed to accumulate an elastic restoring force. When the current flowing through the conductive component and the resistor is abnormally increased, the temperature of the conductive component is increased till a melting point of the low temperature solder, the solder is melted and the conductive component is bounded from the end of the resistor by the elastic restoring force of the elastic deformation portion so as to cut off the temperature safety resistor assembly and protect the rest of the circuits.

### BACKGROUND OF THE INVENTION

1. Field of the Invention

The present invention relates to a resistor assembly, and more particularly relates to a temperature safety resistor assembly capable of being automatically cut off when temperature is too high.

2. Description of the Related Art

A resistor is used to regulate current and voltage in a circuit and is a common component in electrical circuit field. However, the conventional resistor is mainly used to provide a resistant value for an external circuit in accordance with the design of the electrical circuit but no protection is provided in the electrical circuit. Therefore, the conventional electronics is required to install a fuse to prevent a short circuit or a fire incident from occurring in the electrical circuit because of some abnormal circumstances. The installation of the fuse not only increases a cost but also occupies some space in the electronics. Therefore, the further improvement of the conventional resistor is required.

### SUMMARY OF THE INVENTION

In accordance with the aforementioned problems, an objective of the present invention is to provide a temperature safety resistor assembly, which can be cut off automatically when the temperature is too high, to omit the use of a fuse in electronic devices.

To achieve the foregoing objective, the present invention provides a temperature safety resistor assembly comprising:

a shell having an inner surface;

a resistor disposed within the shell and having two ends;

two conductive components disposed within the shell at positions respectively corresponding to the two ends of the resistor and each of the two conductive components including:
an internal connecting end connected to the corresponding end of the resistor;
an external connecting end passing through the shell and extending to an exterior of the shell;

wherein the internal connecting end at each of the two conductive components is welded to one of the two ends of the resistor by a low temperature solder, a melting point of the low temperature solder is higher than or equal to 80° C. and less than or equal to 200° C., and an elastic deformation portion is formed between the internal connecting end and the external connecting end at one of the two conductive components, which is welded with the resistor, and the elastic deformation portion deformed by an external force to accumulate an elastic restoring force.

In the temperature safety resistor assembly, the elastic deformation portion at one of the two conductive components welded with the resistor is coiled to form a torque spring, and the elastic deformation portion with the torque spring is twisted and deformed to accumulate the elastic restoring force.

In the temperature safety resistor assembly, the elastic deformation portion with the torque spring at one of the two conductive components welded with the resistor is mounted around a joint rod and the joint rod is fixed on an inner surface of the shell.

In the temperature safety resistor assembly, the elastic deformation portion at one of the two conductive components welded with the resistor forms a linear shape, and the elastic deformation portion with the linear shape is bended and deformed to accumulate an elastic restoring force.

In the temperature safety resistor assembly, the internal connecting end at each of the two conductive components is welded with the corresponding end of the resistor by the low temperature solder.

In the temperature safety resistor assembly, the internal connecting end at one of the two conductive components is directly fixed at the corresponding end of the resistor, and the internal connecting end at the other one of the two conductive components is welded with the corresponding end of the resistor by the low temperature solder.

In the temperature safety resistor assembly, an assembling structure is disposed on the inner surface of the shell and the resistor is mounted on the assembling structure.

In the temperature safety resistor assembly, the assembling structure of the shell is disposed on top of the shell and the resistor is horizontally mounted on the assembling structure and the external connecting end at each of the two conductive components passes through a bottom of the shell and extends to an exterior of the shell.

In the temperature safety resistor assembly, the assembling structure of the shell is disposed at a side wall of the shell and the resistor is longitudinally mounted on the assembling structure, the two ends of the resistor respectively extend to the top and the bottom of the shell, and the external connecting end at each of the two conductive components passes through a bottom of the shell and extends to an exterior of the shell, the internal connecting end mounted at the corresponding end of the resistor is mounted toward the bottom of the shell, and the internal connecting end welded with the conductive component of the resistor is mounted on the end of the resistor toward the top of the shell.

In the temperature safety resistor assembly, the resistor is longitudinally disposed within the shell and the two ends of the resistor extend to the top and the bottom of the shell respectively, the external connecting end at each of the two conductive components passes through the bottom of the shell and extends to an exterior of the shell, the internal connecting end mounted at the corresponding end of the resistor is mounted toward the bottom of the shell, and the internal connecting end welded with the conductive component of the resistor is mounted on the end of the resistor toward the top of the shell.

In the temperature safety resistor assembly, the elastic deformation portion with the torque spring welded with the conductive component of the resistor is disposed at a position corresponding to the end of the resistor toward the top of the shell.

In the temperature safety resistor assembly, an extending direction from a centre axis of the elastic deformation portion with the torque spring is perpendicular to an extending direction from a long axis of the resistor.

In the temperature safety resistor assembly, an extending direction from a centre axis of the elastic deformation portion with the torque spring and an extending direction from a long axis of the resistor are parallel.

In the temperature safety resistor assembly, the elastic deformation portion with the torque spring welded with the conductive component of the resistor is located at a position corresponding to the end of the resistor extending to the top of the shell and the elastic deformation portion and the end of the shell extending to the bottom of the shell are embedded within the bottom of the shell.

In the temperature safety resistor assembly, the resistor is longitudinally disposed within the shell and the two ends of the resistor respectively extend to the top and the bottom of the shell, a lead is disposed at the end of the resistor toward the top of the shell, and the conductive component welded with the resistor by the low temperature solder includes:

a connecting component and a tension spring, and both of the connecting component and the tension spring are made of conductive material, one end of the tension spring passes through the bottom of the shell and extends to an exterior of the shell, the other end of the tension spring is fixed at the connecting component, the lead is connected with the connecting component by the low temperature solder, and the tension spring is extended and deformed to accumulate the elastic restoring force.

In the temperature safety resistor assembly, the resistor is longitudinally disposed within the shell and two ends of the resistor respectively extend to the top and the bottom of the shell, the conductive component welded with the resistor by the low temperature solder includes a telescopic probe, which is able to elastically stretch in length, a bottom of the telescopic probe is fixed at the bottom of the shell and the telescopic probe includes:

a bottom conductive wire extending to the exterior of the shell and disposed at the bottom of the telescopic probe,

a top conductive wire disposed at the top of the telescopic probe, and the top conductive wire is welded with the end of the conductive component toward the top of the shell by the low temperature solder,

wherein the telescopic probe is depressed to shrink in length.

The aforementioned temperature safety resistor assembly is connected with the circuit on the circuit board by the external connecting end of the conductive component. When the current flowing through the conductive component and the resistor is abnormally increased and the temperature of the conductive component is increased till a melting point of the low temperature solder, the low temperature solder s melted and the internal connecting end of the conductive component is bounded from the end of the resistor because of the elastic restoring force to cut off the temperature safety resistor assembly so as to form a breaker to protect the rest of the circuits.

### BRIEF DESCRIPTION OF THE DRAWINGS

FIG. 1 is a cross-sectional side view at a conductive status in a first preferred embodiment of the present invention;

FIG. 2 is a cross-sectional side view at a cut-off status in the first preferred embodiment of the present invention;

FIG. 3 is a cross-sectional side view at a conductive status in a second preferred embodiment of the present invention;

FIG. 4 is a cross-sectional side view at a conductive status in a third preferred embodiment of the present invention;

FIG. 5 is a cross-sectional side view at a cut-off status in the third preferred embodiment of the present invention;

FIG. 6 is a cross-sectional side view at a conductive status in a fourth preferred embodiment of the present invention;

FIG. 7 is a cross-sectional side view at a conductive status in a fifth preferred embodiment of the present invention;

FIG. 8 is a cross-sectional side view at a cut-off status in the fifth preferred embodiment of the present invention;

FIG. 9 is a cross-sectional side view at a conductive status in a sixth preferred embodiment of the present invention;

FIG. 10 is a cross-sectional side view at a conductive status in a seventh preferred embodiment of the present invention;

FIG. 11 is a cross-sectional side view at a cut-off status in the seventh preferred embodiment of the present invention;

FIG. 12 is a cross-sectional side view at a conductive status in an eighth preferred embodiment of the present invention;

FIG. 13 is a cross-sectional side view at a conductive status in the eighth preferred embodiment of the present invention;

FIG. 14 is a cross-sectional side view at a cut-off status in the eighth preferred embodiment of the present invention;

FIG. 15 is a cross-sectional side view at a conductive status in a ninth preferred embodiment of the present invention;

FIG. 16 is a cross-sectional side view at a cut-off status in the ninth preferred embodiment of the present invention;

FIG. 17 is a cross-sectional side view at a conductive status in a tenth preferred embodiment of the present invention;

FIG. 18 is a cross-sectional side view at a cut-off status in the tenth preferred embodiment of the present invention.

### DETAILED DESCRIPTION OF THE INVENTION

These and other aspects of the embodiments herein will be better appreciated and understood when considered in conjunction with the following description and the accompanying drawings.

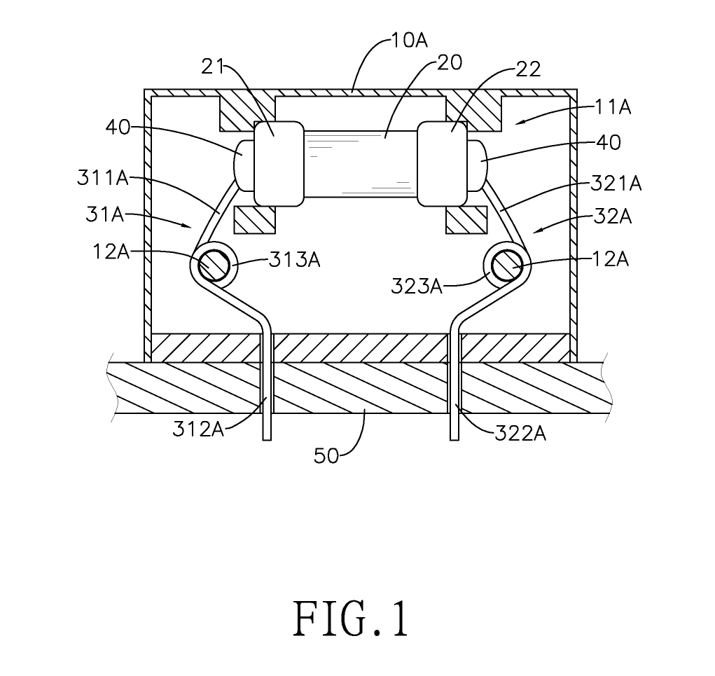

With reference to FIG. 1, a temperature safety resistor assembly includes a shell 10A, a resistor 20 and two conductive components 31A, 32A.

The shell 10A is hollow and includes an inner surface, and an assembling structure 11A is disposed on the inner surface of the shell 10A. The resistor 20 is disposed within the shell 10A and mounted on the assembling structure 11A. The resistor 20 includes two opposite ends 21, 22.

The two conductive components 31A, 32A are disposed within the shell 10A and respectively located at positions corresponding to the two ends 21, 22 of the resistor 20. The conductive component 31A includes an internal connecting end 311A and an external connecting end 312A. The other conductive component 32A includes an internal connecting end 321A and an external connecting end 322A. The internal connecting ends 311A, 321A of the two conductive components 31A, 32A are respectively connected with the corresponding ends 21, 22 of the resistor 20. The external connecting ends 312A, 322A of the two conductive components 31A, 32A pass through the shell 10A and extend to an exterior of the shell 10A. At least one of the internal connecting ends 311A, 321A of the two conductive components 31A, 32A is welded at the corresponding ends 21, 22 of the resistor 20 by a low temperature solder 40. A melting point of the low temperature solder 40 is higher than or equal to 80° C. and less than or equal to 200° C., and two elastic deformation portions 313A, 323A are respectively formed between the internal connecting ends 311A, 321A and the external connecting ends 312A, 322A of the conductive components 31A, 32A. Alternatively, in a different embodiment, only one of the two elastic deformation portions 313A or 323A is formed between the internal connecting ends 311A or 321A and the external connecting ends 312A or 322A of the conductive components 31A or 32A and it is not limited herein. The elastic deformation portions 313A, 323A are deformed by an external force to accumulate an elastic restoring force.

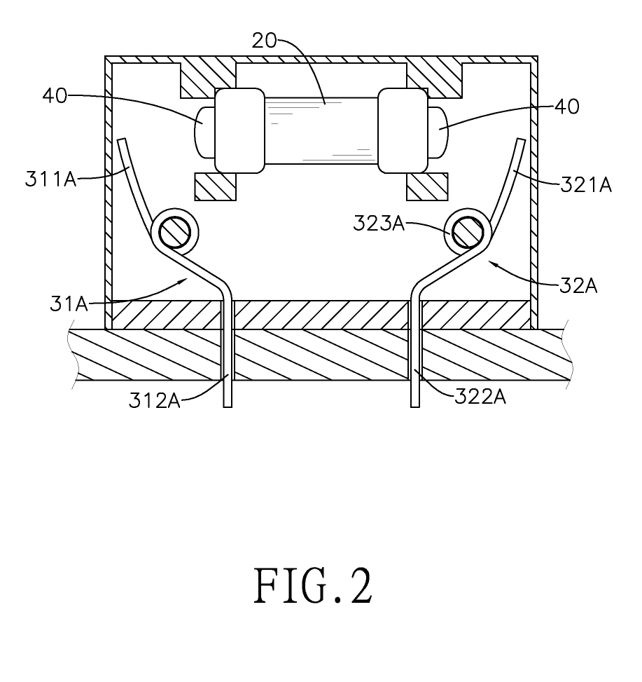

With reference to FIG. 1, the temperature safety resistor assembly in the present invention is to connect a circuit in a circuit board 50 by the external connecting ends 312A, 322A of the conductive components 31A, 32A. With reference to FIG. 2, if the current flowing through the conductive components 31A, 32A and the resistor 20 is abnormally increased, the temperature of the conductive components 31A, 32A is increased. When the temperature of the conductive components 31A, 32A is continually increased till the melting point of the low temperature solder 40, the low temperature solder 40 will be melted. Since the external connecting ends 312A, 322A of the conductive components 31A, 32A are fixed, the internal connecting ends 311A, 321A of the conductive components 31A, 32A are bounced from the ends 21, 22 of the resistor 20 because of the elastic restoring force of the elastic deformation portions 313A, 323A so as to cut off the temperature safety resistor assembly and form a circuit breaker to protect the rest of the circuits.

With reference to FIG. 1, in a first preferred embodiment of the present invention, the assembling structure 11A of the shell 10A is disposed on top of the shell 10A, and the resistor 20 is horizontally disposed on the assembling structure 11A. The two conductive components 31A, 32A are conductive wires and the external connecting ends 312A, 322A of the conductive components 31A, 32A pass through a bottom of the shell 10A and extend to the exterior of the shell 10A. The internal connecting ends 311A, 321A of the two conductive components 31A, 32A are welded at the corresponding ends 21, 22 of the resistors 20 by the low temperature solder 40. The elastic deformation portions 313A, 323A at the two conductive components 31A, 32A welded with the resistor 20 are coiled to form a torque spring and the elastic deformation portions 313A, 323A with the torque spring are twisted and deformed to accumulate the elastic restoring force. When the current is abnormally increased to raise the temperature of the conductive component 31A, 32A so as to melt the low temperature solder 40, the internal connecting ends 311A, 321A are bounded from the resistors 20 to cut off the temperature safety resistor assembly.

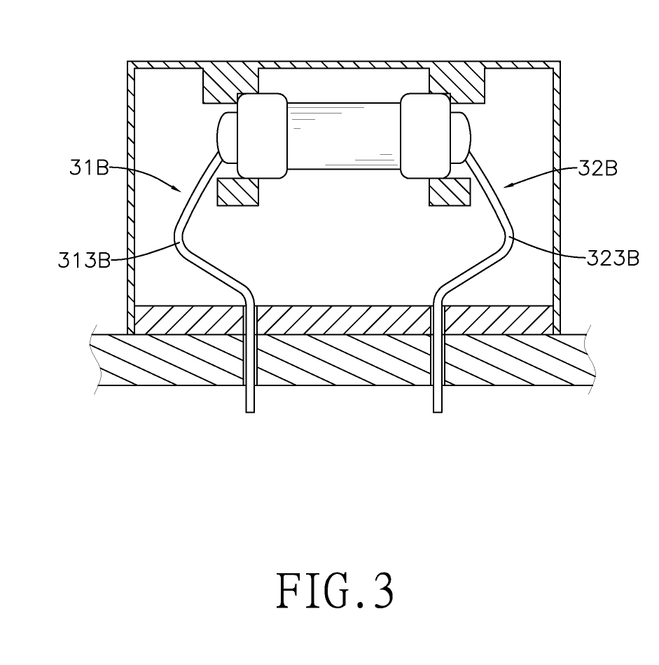

With reference to FIG. 3, in a second preferred embodiment of the present invention, the difference between the first preferred embodiment and the second preferred embodiment is that the elastic deformation portions 313B, 323B in each of the conductive components 31B, 32B are formed in a linear shape. The elastic deformation portions 313A, 323A with the linear shape are bended and deformed to accumulate the elastic restoring force.

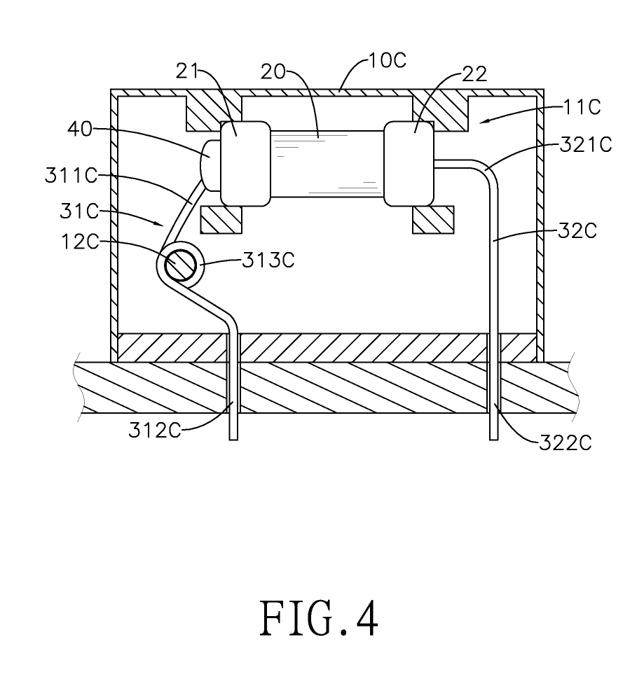

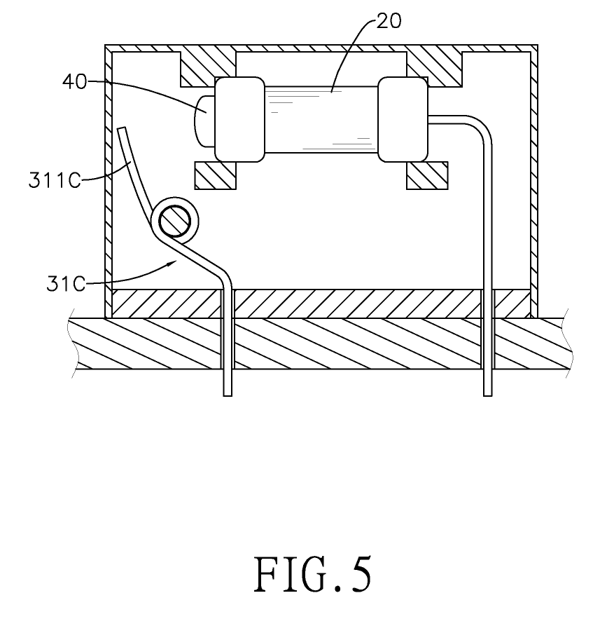

With reference to FIG. 4, in a third preferred embodiment of the present invention, the assembling structure 11C of the shell 10C is disposed on top of the shell 10C, and the resistor 20 is horizontally disposed on the assembling structure 11C. The two conductive components 31C, 32C are conductive wires and the external connecting ends 312C, 322C of the conductive components 31C, 32C pass through a bottom of the shell 10C and extend to the exterior of the shell 10C. The internal connecting end 321C of the conductive components 32C is fixed at the corresponding end 22 of the resistor 20 and the internal connecting end 311C of the conductive component 31C is welded at the corresponding end 21 of the resistors 20 by the low temperature solder 40. The elastic deformation portion 313C at the conductive component 31C welded with the resistor 20 is coiled to form the torque spring, and a joint rod 12C is installed on the inner surface of the shell 10C. The elastic deformation portion 313C with the torque spring is mounted around the joint rod 12C. The elastic deformation portion 313C with the torque spring is twisted and deformed to accumulate the elastic restoring force. With reference to FIG. 5, when the current is abnormally increased to raise the temperature of the conductive components 31C, 32C so as to melt the low temperature solder 40, the internal connecting end 311C is bounded from the resistors 20 to cut off the temperature safety resistor assembly.

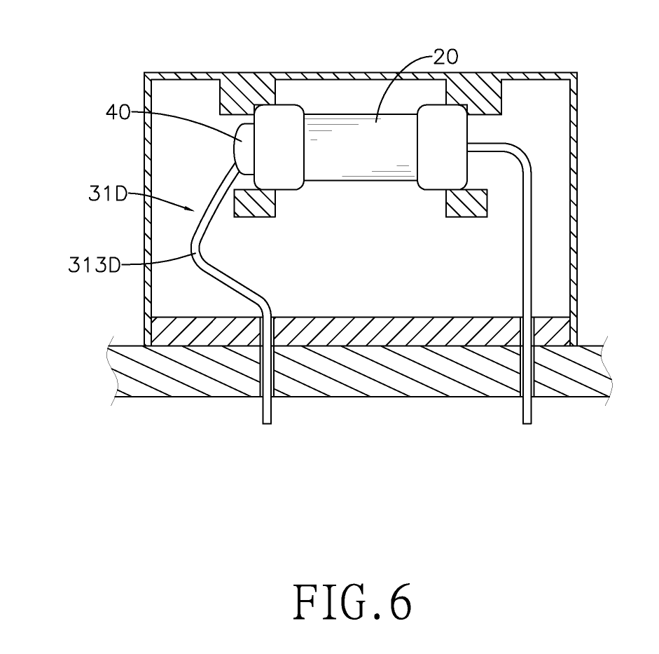

With reference to FIG. 6, in a fourth preferred embodiment of the present invention, the difference between the first preferred embodiment and the fourth preferred embodiment is that the elastic deformation portion 313D in the conductive component 31D is formed in the linear shape. The elastic deformation portion 313D with the linear shape is bended and deformed to accumulate the elastic restoring force.

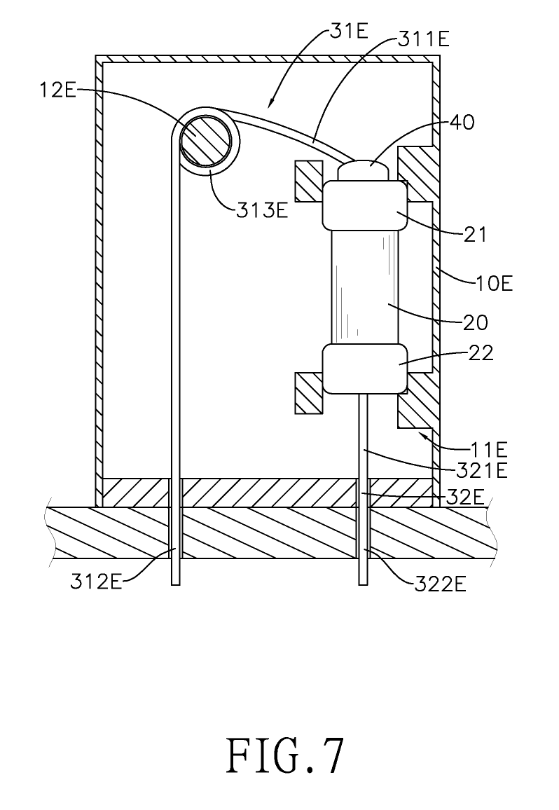

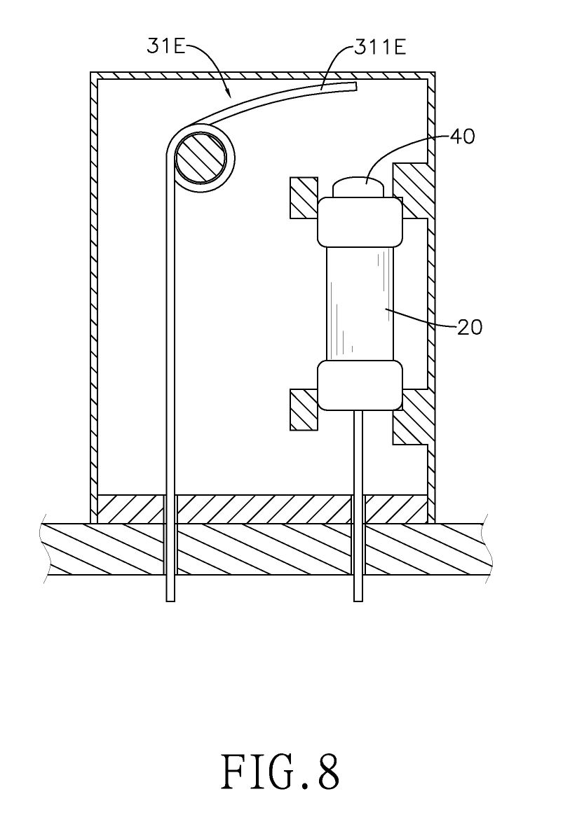

With reference to FIG. 7, in a fifth preferred embodiment of the present invention, the assembling structure 11E of the shell 10E is disposed on top of the shell 10E, and the resistor 20 is longitudinally disposed on the assembling structure 11E. The two conductive components 31E, 32E are conductive wires and the external connecting ends 312E, 322E of the conductive components 31E, 32E pass through a bottom of the shell 10E and extend to the exterior of the shell 10E. The internal connecting end 321E of the conductive component 32E is directly fixed at the end 22 of the resistor 20, which extends to the bottom of the shell 10E. The other internal connecting end 311E of the conductive component 31E is welded at the end 21, which extends to the top of the shell 10E, of the resistor 20 by the low temperature solder 40. The elastic deformation portion 313E of the conductive component 31E welded with the conductive component 31E of the resistor 20 is coiled to form a torque spring. The position of the elastic deformation portion 313E is corresponding to the end 21, which extends to the top of the shell 10E, of the resistor 20. A direction extending from a centre axis of the elastic deformation portion 313E with the torque spring is perpendicular to a direction extending from a long axis of the resistor 20. A joint rod 12E is horizontally disposed on the inner surface of the shell 10E and the elastic deformation portion 313E with the torque spring of the conductive component 31E is mounted around the joint rod 12E. With reference to FIG. 8, when the current is abnormally increased to raise the temperature of the conductive component 31E so as to melt the low temperature solder 40, the internal connecting end 311E is bounded from the resistor 20 because of the melting of the low temperature solder 40 to cut off the temperature safety resistor assembly.

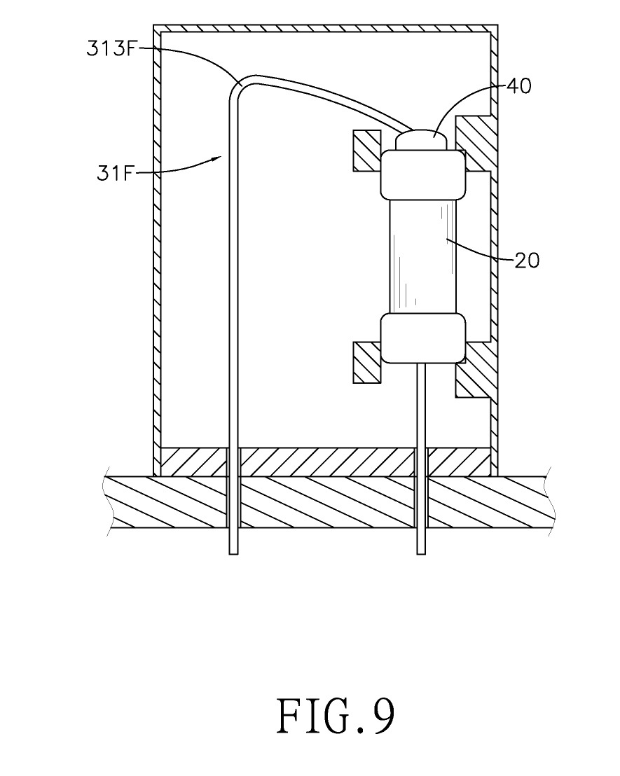

With reference to FIG. 9, in a sixth preferred embodiment of the present invention, the difference between the sixth preferred embodiment and the fifth preferred embodiment is that the elastic deformation portion 313F in the conductive component 31F is formed in the linear shape and the elastic deformation portion 313F is welded at the resistor 20 by the low temperature solder 40. The elastic deformation portion 313F with the linear shape is bended and deformed to accumulate the elastic restoring force.

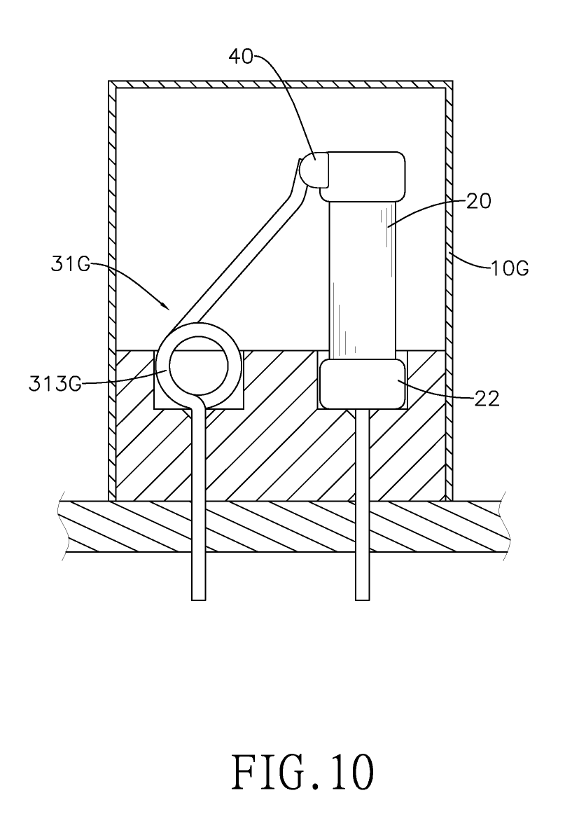

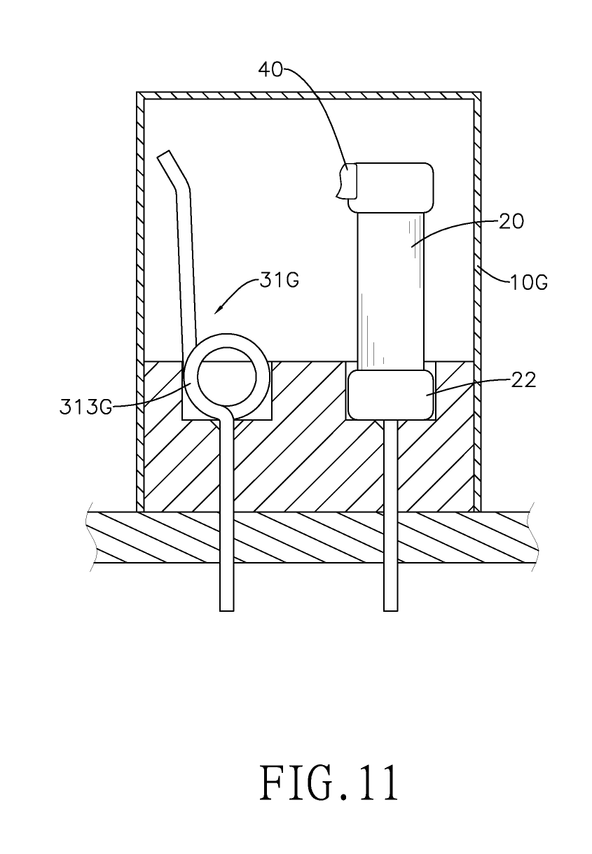

With reference to FIG. 10 and FIG. 11, in a seventh preferred embodiment of the present invention, the difference between the seventh preferred embodiment and the fifth preferred embodiment is that the position of the elastic defoiination portion 313G in the conductive component 31G is corresponding to the end 22, which extends to the bottom of the shell 10G, of the resistor 20 and the elastic deformation portion 313G and the end 22 of the resistor 20 are all embedded within the bottom of the shell 10G.

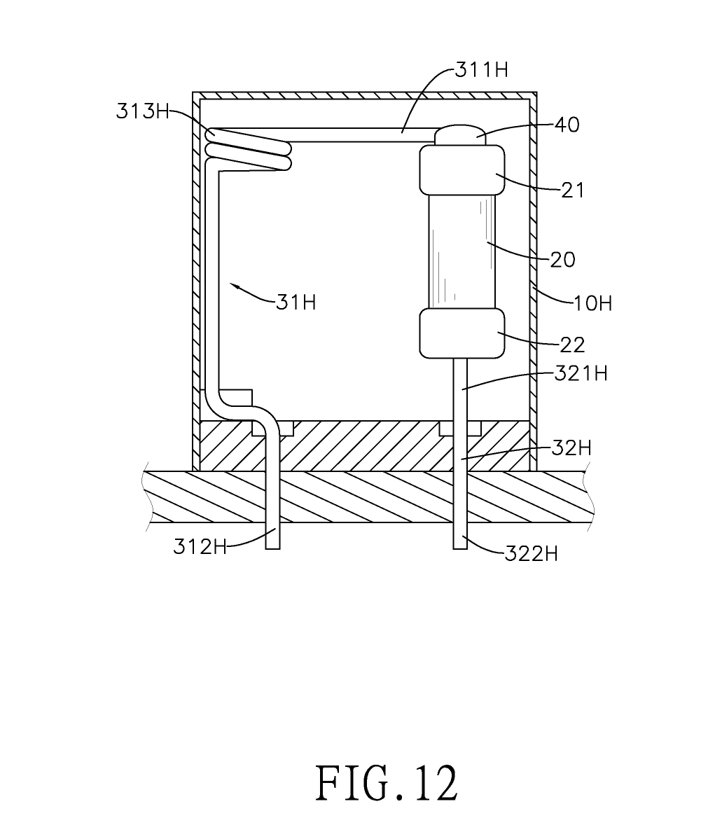

With reference to FIG. 12, in an eighth preferred embodiment of the present invention, the resistor 20 is longitudinally disposed on the assembling structure 11H and the two ends 21, 22 of the resistor 20 respectively extend to the top and the bottom of the shell 10H. The two conductive components 31H, 32H are conductive wires and the external connecting ends 312H, 322H of the conductive components 31H, 32H pass through a bottom of the shell 10H and extend to the exterior of the shell 10H. The internal connecting end 321H of the conductive component 32H is directly fixed at the end 22 of the resistor 20, which extends to the bottom of the shell 10H. The other internal connecting end 311H of the conductive component 31H is welded at the end 21, which extends to the top of the shell 10H, of the resistor 20 by the low temperature solder 40.

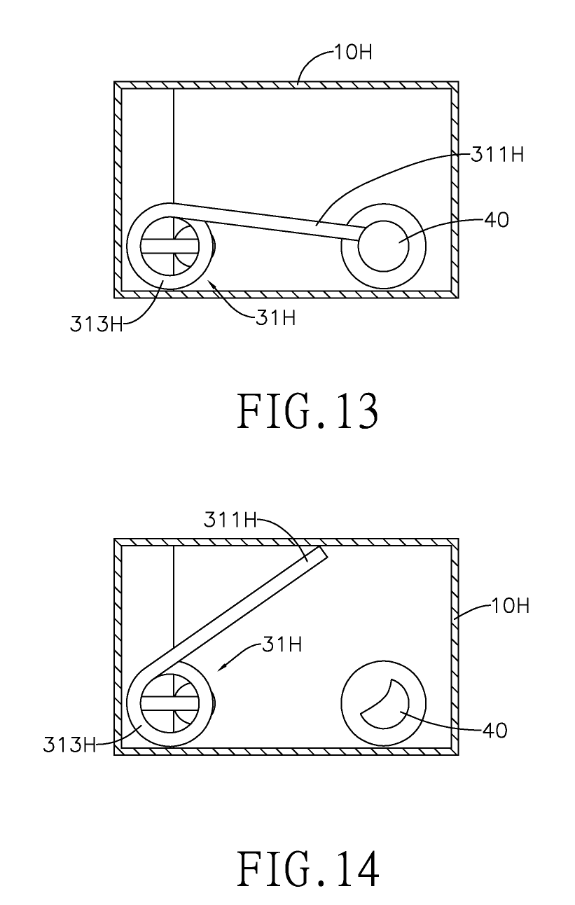

The elastic deformation portion 313H of the conductive component 31H is welded at the end 21, which extends to the top of the shell 10H, of the resistor 20 by the low temperature solder 40 and is coiled to form a torque spring. A direction extending from a centre axis of the elastic deformation portion 313H with the torque spring and a direction extending from a long axis of the resistor 20 are parallel. The elastic deformation portion 313H with the torque spring is twisted and deformed to accumulate the elastic restoring force. With reference to FIG. 13 and FIG. 14, when the current is abnormally increased, the inner connecting end 311H of the conductive component 31H is bounded from the resistor 20 by the low temperature solder 40 because of the melting of the low temperature solder 40 to cut off the temperature safety resistor assembly.

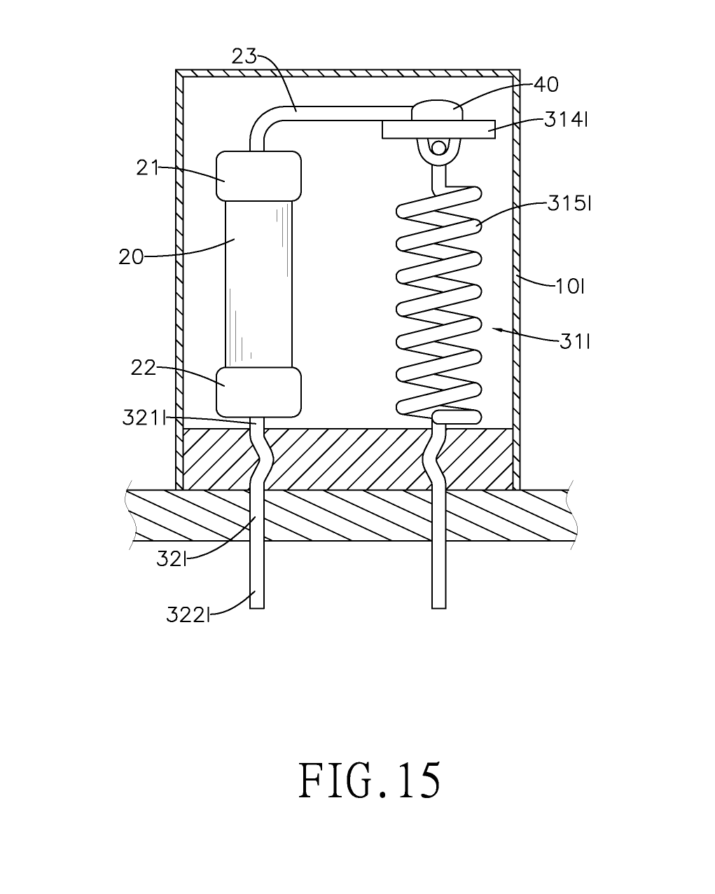

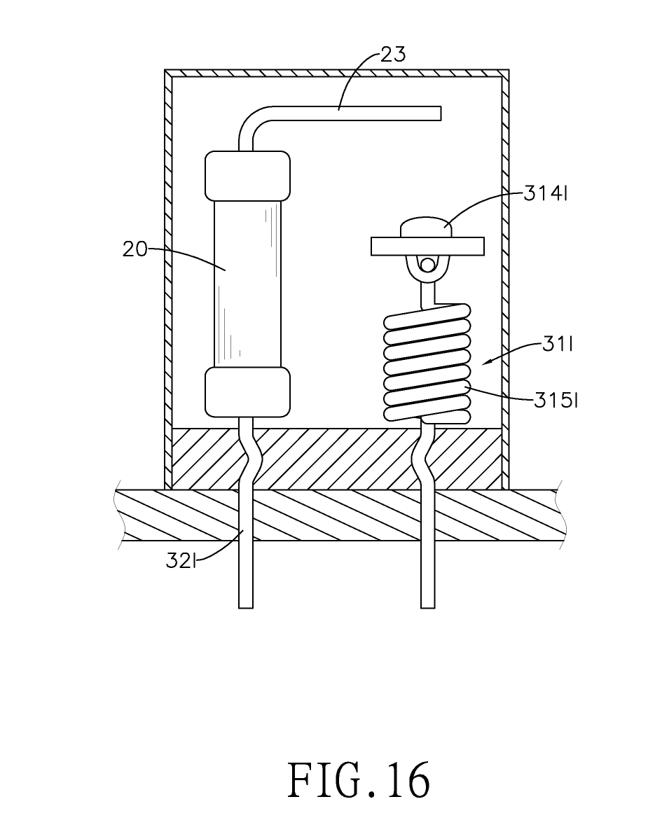

With reference to FIG. 15, in a ninth preferred embodiment of the present invention, the resistor 20 is longitudinally disposed on the assembling structure 11I and the two ends 21, 22 of the resistor 20 respectively extend to the top and the bottom of the shell 10I. One of the conductive components 32I is a conductive wire and the internal connecting end 321I of the conductive component 32I is directly fixed at the end 22 of the resistor 20, which extends to the bottom of the shell 10I. The other conductive component 31I includes a connecting component 314I and a tension spring 315I. The connecting component 314I and the tension spring 315I are conductive materials. One end of the tension spring 315I passes through the bottom of the shell 10I and extends to the exterior of the shell 10I, and the other end of the tension spring 315I is connected with the connecting component 314I. A lead 23 is further adapted and extends to the end 21, which extends to the top of the shell 10I, of the resistor 20 and the lead 23 is welded with the connecting component 314I by the low temperature solder 40. At this moment, the tension spring 315I extends and is deformed to accumulate the elastic restoring force. With reference to FIG. 16, when the current is abnormally increased to raise the temperature of the conductive components 31I, 32I so as to melt the low temperature solder 40 between the lead 23 and the connecting component 314I, the elastic rebounding force of the tension spring 315I pulls the connecting component 314I to be released from the lead 23 so as to cut off the temperature safety resistor assembly.

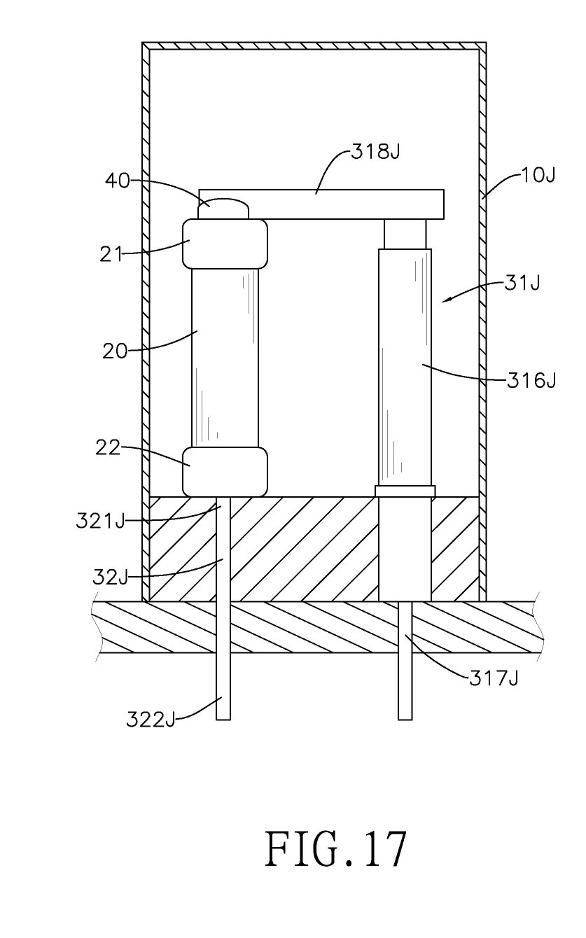

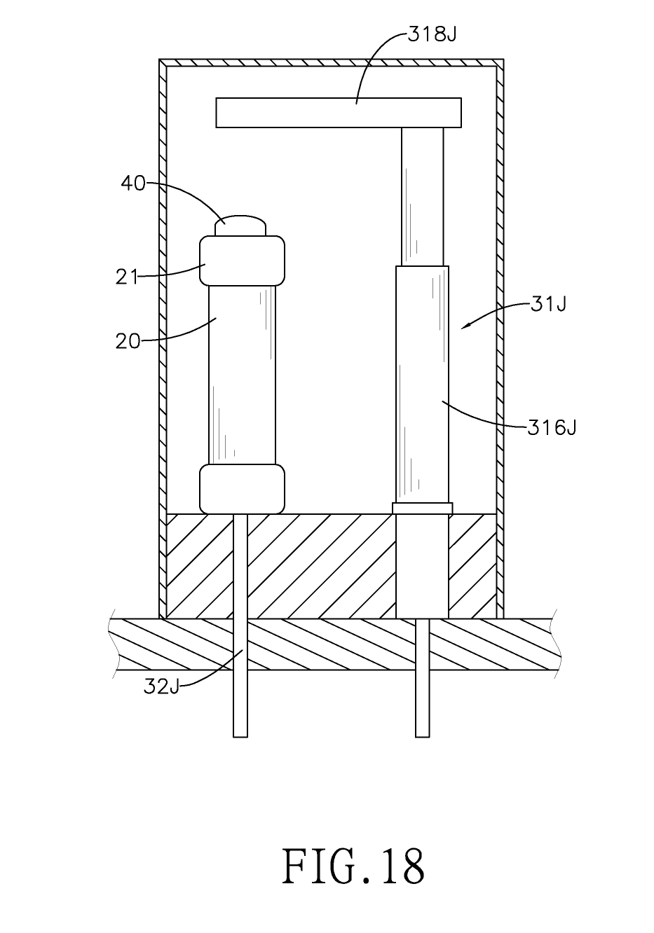

With reference to FIG. 17, in a tenth preferred embodiment of the present invention, the resistor 20 is longitudinally disposed within the shell 10J and the two ends 21, 22 of the resistor 20 respectively extend to the top and the bottom of the shell 10J. One of the conductive components 32J is a conductive wire and the internal connecting end 321J of the conductive component 32J is directly fixed at the end 22 of the resistor 20, which extends to the bottom of the shell 10J. The other conductive component 31J includes a telescopic probe 316J and the telescopic probe's 316J length elastically extends. The bottom of the telescopic probe 316J is fixed within the bottom of the shell 10J and a bottom conductive wire 317J is disposed at the bottom of the shell 10J and extends to the exterior of the shell 10J. A top conductive wire 318J is disposed on the top of the telescopic probe 316J and the top conductive wire 318J is welded with the end 21 of the resistor 20, which extends to the top of the shell 10J. At this moment, the telescopic probe 316J is depressed to shrink in length. With reference to FIG. 18, when the current is abnormally increased to increase the temperature of the conductive components 31J, 32J so as to melt the low temperature solder 40 between the top conductive wire 318J and the end 21 of the resistor 20 to increase the length of the telescopic probe 316J by the elastic restoring force to release the top conductive wire 318J from the resistor 20 so as to cut off the temperature safety resistor assembly.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A temperature safety resistor assembly, comprising:
a shell being hollow and having an inner surface;
a resistor disposed within the shell and having two ends;
two conductive components disposed within the shell at positions respectively corresponding to the two ends of the resistor and each one of the two conductive components including:
an internal connecting end connected to a corresponding one of the two ends of the resistor; and
an external connecting end passing through the shell and extending to an exterior of the shell;
wherein the internal connecting end of at least one of the two conductive components is welded to a corresponding one of the two ends of the resistor by a low temperature solder, a melting point of the low temperature solder is within a range higher than or equal to 80° C. and less than or equal to 200° C., and an elastic deformation portion deformed by an external force to accumulate an elastic restoring force is formed between the internal connecting end and the external connecting end of the conductive component that is welded to the resistor by the low temperature solder.

2. The temperature safety resistor assembly as claimed in claim 1, wherein the elastic deformation portion in at least one of the two conductive components welded to the resistor by the low temperature solder is coiled to form a torque spring, such that the elastic deformation portion with the torque spring is twisted and deformed to accumulate the elastic restoring force.

3. The temperature safety resistor assembly as claimed in claim 2, wherein the elastic deformation portion with the torque spring in at least one of the two conductive components welded to the resistor is mounted around a joint rod and the joint rod is fixed on an inner surface of the shell.

4. The temperature safety resistor assembly as claimed in claim 1, wherein the elastic deformation portion in at least one of the two conductive components welded to the resistor forms a linear shape and the elastic deformation portions with the linear shape is bended and deformed to accumulate the elastic restoring force.

5. The temperature safety resistor assembly as claimed in claim 1, wherein the internal connecting ends of the two conductive components are welded to the two ends of the resistor by the low temperature solders respectively.

6. The temperature safety resistor assembly as claimed in claim 1, wherein the internal connecting end of one of the two conductive components is directly fixed to one of the two ends of the resistor, and the internal connecting end of the other conductive component is welded to the other one of the two ends of the resistor by the low temperature solder.

7. The temperature safety resistor assembly as claimed in claim 1, wherein an assembling structure is disposed on the inner surface of the shell and the resistor is mounted on the assembling structure.

8. The temperature safety resistor assembly as claimed in claim 7, wherein the assembling structure of the shell is disposed on a top of the shell and the resistor is horizontally mounted on the assembling structure and the external connecting end at each of the two conductive components passes through a bottom of the shell and extends to the exterior of the shell.

9. The temperature safety resistor assembly as claimed in claim 7, wherein the assembling structure of the shell is disposed at a side wall of the shell and the resistor is longitudinally mounted on the assembling structure, the two ends of the resistor respectively extends to a top and a bottom of the shell, and the external connecting end at each of the two conductive components passes through the bottom of the shell and extends to an exterior of the shell, the internal connecting end mounted at one of the two ends of the resistor is mounted toward the bottom of the shell, and the internal connecting end welded to the conductive component of the resistor is mounted on the other end of the resistor toward the top of the shell.

10. The temperature safety resistor assembly as claimed in claim 2, wherein the resistor is longitudinally disposed within the shell and the two ends of the resistor extends to a top and a bottom of the shell respectively, the external connecting end at each of the two conductive components passes through the bottom of the shell and extends to the exterior of the shell, the internal connecting end mounted at one of the two ends of the resistor is mounted toward the bottom of the shell, and the internal connecting end welded to the conductive component of the resistor is mounted on the other end of the resistor toward the top of the shell.

11. The temperature safety resistor assembly as claimed in claim 10, wherein the elastic deformation portion of the conductive component welded to the resistor is disposed at a position corresponding to one of the two ends of the resistor extending to the top of the shell.

12. The temperature safety resistor assembly as claimed in claim 11, wherein an extending direction from a centre axis of the elastic deformation portion with the torque spring is perpendicular to an extending direction from a long axis of the resistor.

13. The temperature safety resistor assembly as claimed in claim 11, wherein an extending direction from a centre axis of the elastic deformation portion with the torque spring and an extending direction from a long axis of the resistor are parallel.

14. The temperature safety resistor assembly as claimed in claim 10, wherein the elastic deformation portion with the torque spring welded to the conductive component of the resistor is located at a position corresponding to one of the two ends of the resistor extending to the top of the shell and the elastic deformation portion and the end of the shell extending to the bottom of the shell are embedded within the bottom of the shell.

15. The temperature safety resistor assembly as claimed in claim 1, wherein the resistor is longitudinally disposed within the shell and the two ends of the resistor respectively extend to a top and a bottom of the shell, a lead is disposed at the end of the resistor toward the top of the shell, and the conductive component welded to the resistor by the low temperature solder includes:
a connecting component and a tension spring, both of the connecting component and the tension spring made of conductive material, one end of the tension spring passing through the bottom of the shell and extending to the exterior of the shell, the other end of the tension spring fixed at the connecting component, the lead connected with the connecting component by the low temperature solder, and the tension spring extending and deformed to accumulate the elastic restoring force.

16. The temperature safety resistor assembly as claimed in claim 1, wherein the resistor is longitudinally disposed within the shell and two ends of the resistor respectively extend to a top and a bottom of the shell, the conductive component welded to the resistor by the low temperature solder includes a telescopic probe, which is able to elastically stretch in length, a bottom of the telescopic probe is fixed at the bottom of the shell and the telescopic probe includes:
a bottom conductive wire extending to the exterior of the shell and disposed at the bottom of the telescopic probe,
a top conductive wire disposed at the top of the telescopic probe, and the top conductive wire welded to the end of the conductive component toward the top of the shell by the low temperature solder,
wherein the telescopic probe is depressed to shrink in length.
